(19) United States
(12) Patent Application Publication
(10) Pub. No.: US 2023/0181405 A1
(43) Pub. Date: Jun. 15, 2023

(54) TRACTION DEVICE

(71) Applicant: SNJ Patents, LLC, Palm Beach Gardens, FL (US)

(72) Inventor: Charles Theofilos, M.D., Palm Beach Gardens, FL (US)

(21) Appl. No.: 18/064,053

(22) Filed: Dec. 9, 2022

Related U.S. Application Data
(60) Provisional application No. 63/265,221, filed on Dec. 10, 2021.

(51) Int. Cl. A61H 1/02

(52) U.S. Cl. CPC A61H 1/0218; A61H 2203/0456; A61H 2201/1642; A61H 2201/1246; A61H 2201/0134; A61H 2201/0161; A61H 2201/165; A61H 2201/1635; A61H 2201/0192; A61H 2201/503; A61H 2205/081

(57) ABSTRACT

A traction device for treating or alleviating back pain and/or sciatica. The traction device is designed to provide the user with a mechanism to pull their lower body, allowing for traction of the lower back. The traction device may also include mechanisms to orient the user's feet at different angle orientations, thus allowing traction to the user's hips, user's hips and back, or the user's back. The traction device may include an upper section designed to support a user's upper body, an intermediate section designed to support a user's mid-section, and a lower section designed to support a user's lower body.

### CROSS REFERENCE TO RELATED APPLICATIONS

In accordance with 37 C.F.R. 1.76, a claim of priority is included in an Application Data Sheet filed concurrently herewith. Accordingly, the present invention claims priority to U.S. Provisional Patent Application No. 63/265,221, entitled “TRACTION DEVICE”, filed Dec. 10, 2021. The contents of the above referenced application are incorporated herein by reference in their entirety.

### FIELD OF THE INVENTION

Embodiments of the invention relate to medical devices; to medical devices for use in treating or alleviating back pain; and more particularly, to a traction device designed to provide the user with a mechanism to pull their lower body, allowing for traction of the low back.

### BACKGROUND OF THE INVENTION

As the second leading cause of visits to the emergency room and one of the leading causes of missed work time, low back pain is a very common medical condition affecting large numbers of individuals. People suffering low back pain usually get relief from traction of the lumbar spine. Currently, the only apparatus individuals suffering from low back pain have to help treat such aliments, and other related conditions like sciatica, from home is the use of an inversion table. An inversion table allows an individual suffering from back pain to hang upside down so his/her weight provides traction to the individual's lower back, thus providing relief of back pain and/or sciatica. The disadvantage of using an inversion table relates to patient orientation required to use the device. After five minutes of being placed in an upside down position, large volumes of blood flow to the user's head, causing significant headaches and often times resulting in the user passing out. Accordingly, individuals using an inversion table have limited treatment time.

Alternative means to using an inversion table require seeking services from medical professionals, such as a chiropractor or physical therapist. While such treatments may be effective, they are costly, usually costing $300-$500 per session, and requiring trips outside the patient's home.

Devices that provide patients a viable, in home treatment solution are needed.

### SUMMARY OF THE INVENTION

Embodiments of the invention relate to medical devices used for treating or alleviating back pain. Embodiments of the device allow users to perform lower back traction on themselves, in a recumbent position for extended periods of time at home or wherever they choose. The device allows a person to lay down and attach their feet to feet holders (boots) that are configured to be rotated, preferably up to 45 (0-45) degrees, or up to about 45 degrees, or alternatively up to 90 degrees (0-90), or up to about 90 degrees, in either direction or neutral. As used herein, the use of “about” means a value of 5%-10% above or below the stated value. When the user's feet are inverted, the device locks the hips into the hip socket so traction that is performed is more isolated for the low back. If the feet are everted 45 degrees, the hips are unlocked from the hip socket and traction that is performed occurs primarily at the hip joint. If the feet are neutral, then traction occurs at both areas. The device preferably includes chest straps, shoulder restraints, and a handle to prevent a person being pulled towards the feet during traction. A user is able to perform traction as long as they want without having the side effects of headaches. Furthermore, the user may perform such actions in the comfort of their home, or wherever they want, without the additional expense of visiting a therapist.

Accordingly, it is an objective of the invention to provide embodiments of a device for treating or alleviating back pain.

It is a further objective of the invention to provide embodiments of a device configured to provide a user with a mechanism to pull their lower body, allowing for traction of the low back.

It is yet another objective of the invention to provide a traction device configured to orient the user's feet at different angle orientations, thus allowing traction to the user's hips and back.

It is a still further objective of the invention to provide a traction device configured to orient the user's feet at different angle orientations, thus allowing traction primarily to the user's back.

It is yet another objective of the invention to provide a traction device configured to orient the user's feet at different angle orientations, thus allowing traction primarily to the user's hips.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1A is an illustrative embodiment of a traction device;

FIG. 1B is an illustrative embodiment of the traction device with a female human resting upon the traction device;

FIG. 2 is a top view of the traction device;

FIG. 3A is an exploded view of the traction device;

FIG. 3B is a schematic illustration of an illustrative embodiment of a pneumatic actuator;

FIG. 4A is a close-up view of the traction device actuator source generator attached to portions of the intermediate frame portion;

FIG. 4B is a top, close-up view of the intermediate frame portion, illustrating the pneumatic actuators and piston connection plates;

FIG. 4C is a bottom, close-up view of the intermediate frame portion, illustrating the pneumatic actuators and piston connection plates;

FIG. 5 is a close-up view of the first foot/ankle support and the second foot/ankle support secured to the lower frame portion;

FIG. 6 is an alternative close-up view of the first foot/ankle support and the second foot/ankle support secured to the lower frame portion;

FIG. 7 illustrates the first foot/ankle support and the second foot/ankle support aligned in a generally parallel orientation;

FIG. 8 illustrates the first foot/ankle support and the second foot/ankle support aligned in a non-parallel, diverging orientation;

FIG. 9 illustrates the first foot/ankle support and the second foot/ankle support aligned in a non-parallel, converging orientation;

FIG. 10 is a perspective view of an embodiment of the traction device in the folded stage;

FIG. 11 is an alternative perspective view of the traction device in the folded stage;

FIG. 12 is a top view of the traction device in the folded stage; and

FIG. 13 is a side view of the traction device in the folded stage.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

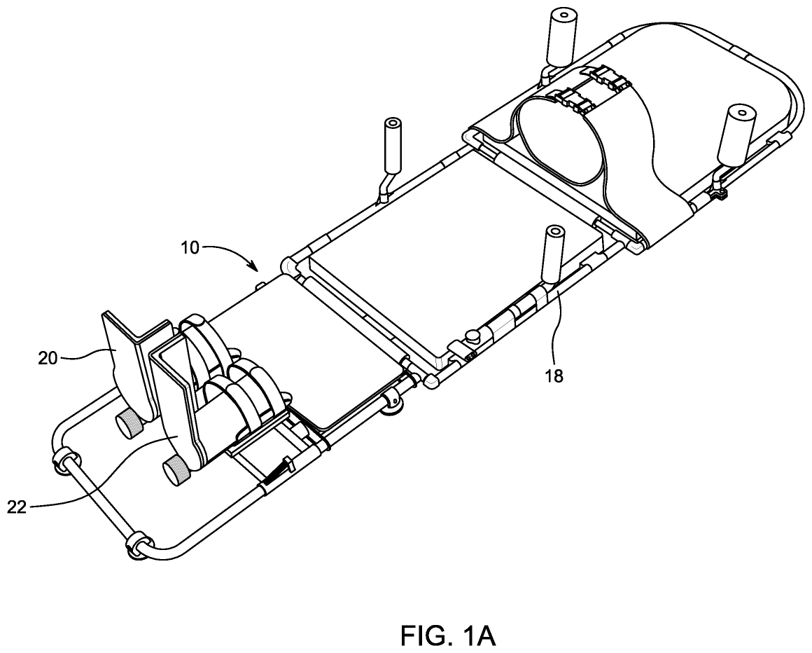

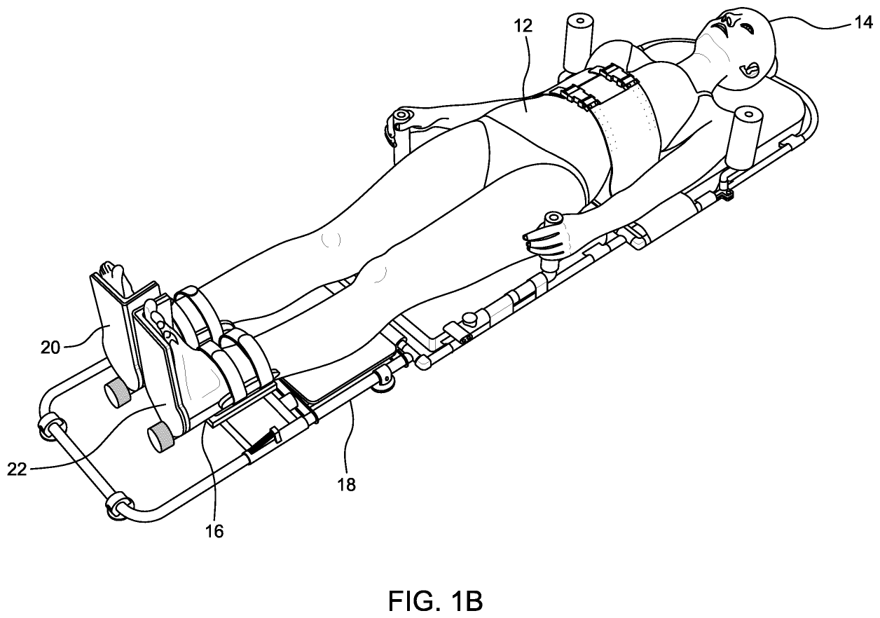

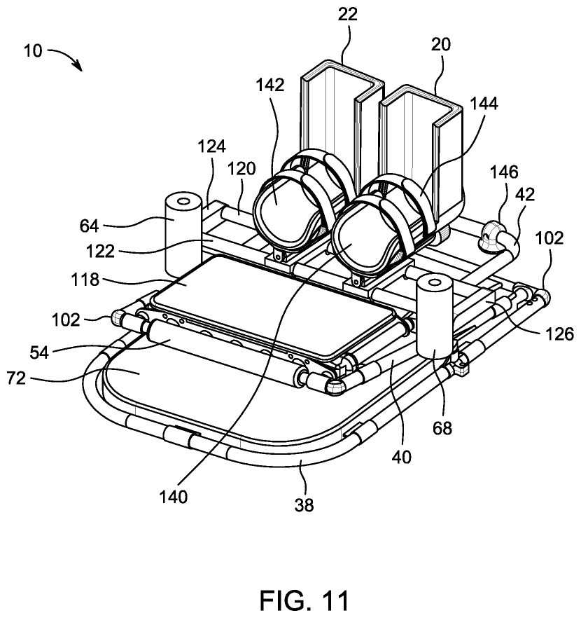

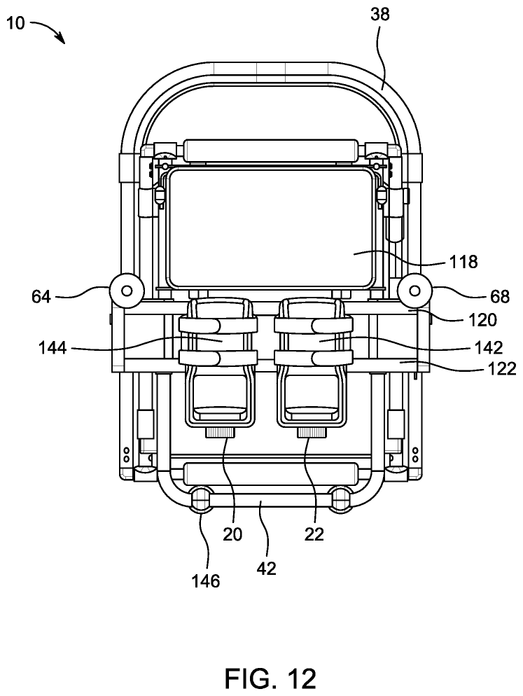

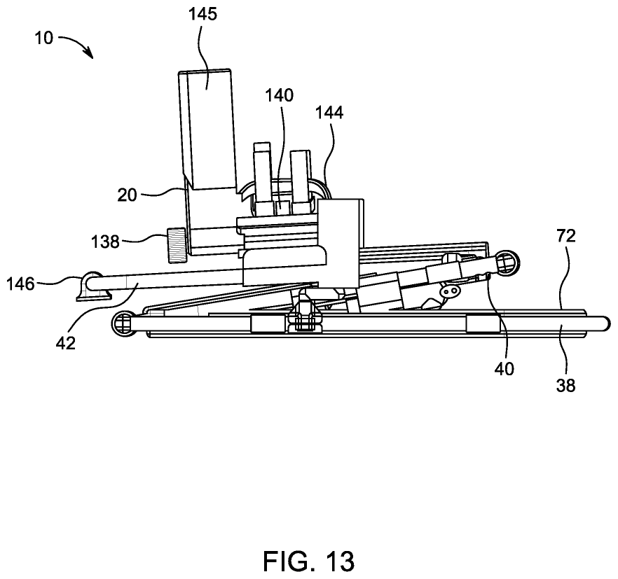

Referring to FIGS. 1A-13, illustrative embodiments of a device for treating or alleviating back pain, referred to generally as a traction device 10, is shown. The traction device 10 is designed to provide the user with a mechanism to pull their lower body, allowing for traction of the lower back. The traction device 10 may also include mechanisms to orient the user's feet at different angle orientations, thus allowing traction to the user's hips, user's hips and back, or the user's back. Referring specifically to FIG. 1B, the traction device 10 is shown with a female human 12 resting thereupon. As illustrated, the female human 12 rests on the traction device 10 in a position in which her head 14 rests at one end and her feet 16 rest at a second, opposing end.

The traction device 10 includes a frame 18 (see FIGS. 1A and 1B). The frame 18 may be constructed as a single unit. Alternatively, the frame 18 may be constructed of several pieces which, when fit together, form a single unit. Regardless of how constructed, the frame 18 may be made of any material, or combinations of materials, that provide or support functionality, including material specifically made for use in medical devices if required. In an illustrative embodiment, the frame 18 may be made of a lightweight metal, such as aluminum or titanium.

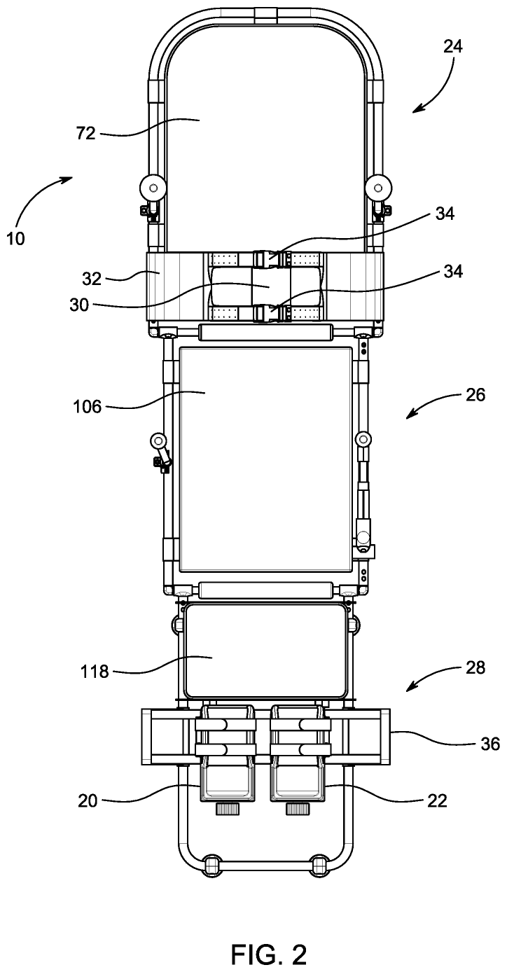

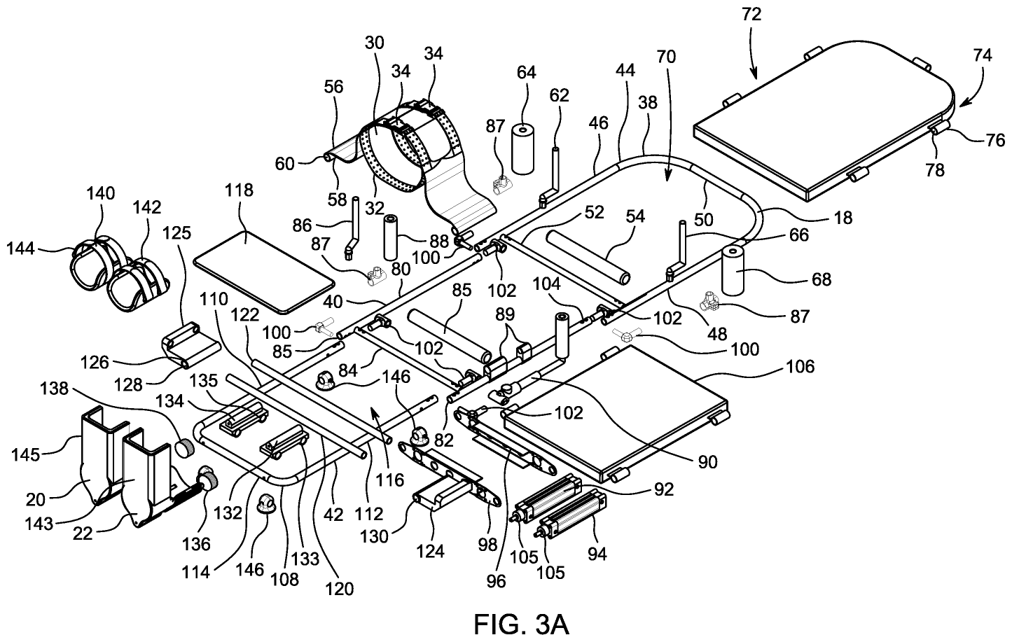

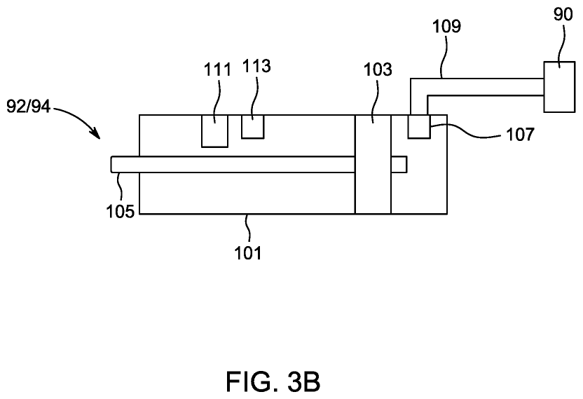

Referring to FIGS. 2 and 3A, the traction device 10 is shown with foot/ankle supports, first foot/ankle support 20 and second foot/ankle support 22. The traction device 10 is designed to support a user in the supine position, i.e. lying horizontally with the face and torso facing up. Accordingly, the traction device 10 may include an upper section 24 designed to support the user's upper body, an intermediate section 26 designed to support the user's mid-section, and a lower section 28 designed to support the user's lower body. A first user restraint, referred to generally as an upper body restraint 30 may include a chest strap 32 positioned at or near the upper section 24. The chest strap 32 may be secured to a portion of the frame 18, and is designed to secure the user at or around his/her chest area, thus preventing or minimizing user movement in an up/down direction or side to side direction. The chest strap 32 may assume a shape of a cuff, having securing latches 34 that allow for adjustment of the size of the chest strap 32 fitted to the user. Alternatively, portions of the chest strap 32 may include loop and hook fasteners, i.e. VELCRO, to allow for adjustable loosening or tightening fitting to the user. A second user restraint, referred to generally as a lower body restraint 36, is positioned at the lower section 28. The lower body restraint 36 is designed to secure the user's legs and/or position the user's feet in a preferred orientation or direction.

The frame 18 may include an upper frame portion 38, an intermediate frame portion 40, and a lower frame portion 42. The upper frame portion 38 may include a u-shaped body 44 having a first arm 46, a second arm 48, and a base bar 50 separating the first arm 46 and the second arm 48. The upper frame portion 38 may also include a cross bar 52 with a soft cover 54. The chest strap 32 may include upper frame portion securing members 56, illustrated herein as a bar 58 with openings 60. The openings 60 may be sized and shaped to allow the bar 58 to fit over the upper frame portion u-shaped body first arm 46 and the upper frame portion u-shaped body second arm 48. Alternatively, the chest strap 32 may include a clamp or other securing mechanisms, such as hook and loop fasteners, i.e. VELCRO, as a mechanism to secure to the upper frame portion u-shaped body first arm 46 and the upper frame portion u-shaped body second arm 48. Attached to, or integrally formed therefrom, the upper frame portion u-shaped body first arm 46 is a first armpit support bar 62. The first armpit support bar 62 may have a first armpit bar soft cover 64. Attached to, or integrally formed thereof, the upper frame portion u-shaped body second arm 48 is a second armpit support bar 66. The second armpit support bar 66 may have a second armpit bar soft cover 68. The u-shaped body 44 and the cross bar 52 may form an upper frame portion interior 70. The upper frame portion interior 70 is preferably sized to receive a first body support structure 72, illustrated herein as a soft mat configured to support portions of the upper body of the individual using the traction device 10. The first body support structure 72 may include one or more upper frame portion securing members 74, illustrated herein as small cylindrical shaped bodies 76 with openings 78. The openings 78 may be sized and shaped to allow the cylindrical shaped bodies 76 to fit over the upper frame portion u-shaped body first arm 46, the upper frame portion u-shaped body second arm 48, and the base bar 50. Other securing members 74, such as hook and loop fasteners (VELCRO strips), may be used as well.

The intermediate frame portion 40 may include a first member 80, a second member 82, and a cross-bar 84 connecting the first member 80 and the second member 82. The cross-bar 84 may also include a soft cover 85. Both the first member 80 and the second member 82 are illustrated as elongated bars having openings 85 on both ends to allow for connection to portions of the upper frame portion 38 and the lower frame portion 42. Attached to, or integrally formed therefrom, the intermediate frame portion first member 80 is an adjustable hand grip 86. The adjustable hand grip 86 is configured to be moveable and securable (using adjustable base connector 87) anywhere along the length of the intermediate frame portion first member 80 80. The adjustable hand grip 86 may have a soft cover 88. Attached (via an adjustable connector 89) to the intermediate frame portion second member 82 is a traction device actuator source generator 90, illustrated herein as an air pump. The actuator source generator 90 is operationally connected to actuators 92 and 94, illustrated herein as pneumatic actuators. The actuator source generator 90 is also removably connected to the frame, allowing the user to use/operate when lying down. The pneumatic actuators 92 and 94 are secured to or housed within piston connection plates 96 (back mount) and 98 (front mount).

The pneumatic actuators 92 and 94 may be standard pneumatic cylinders. In an illustrative example, the pneumatic actuators 92 and 94 may include a cylindrical housing 101, a piston 103, a piston rod 105 connected to the piston 103 and extending out of the cylindrical housing 101, an air intake 107 operatively connected to the traction device actuator source generator 90 (air pump) via tubing 109, an air outlet 111, and a release valve 113, see FIG. 3B. Alternative pneumatic actuators known to one of skill in the art may be used as well.

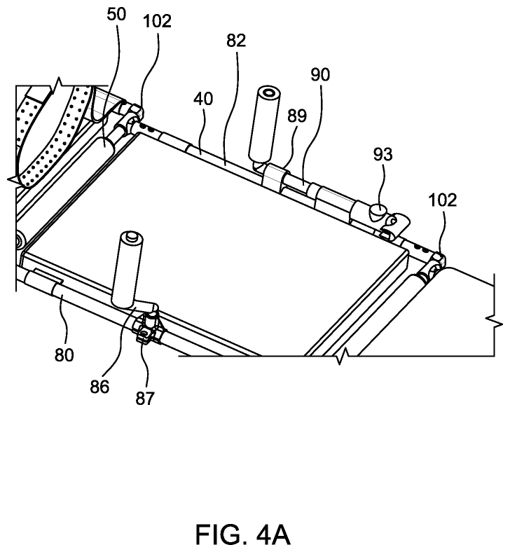

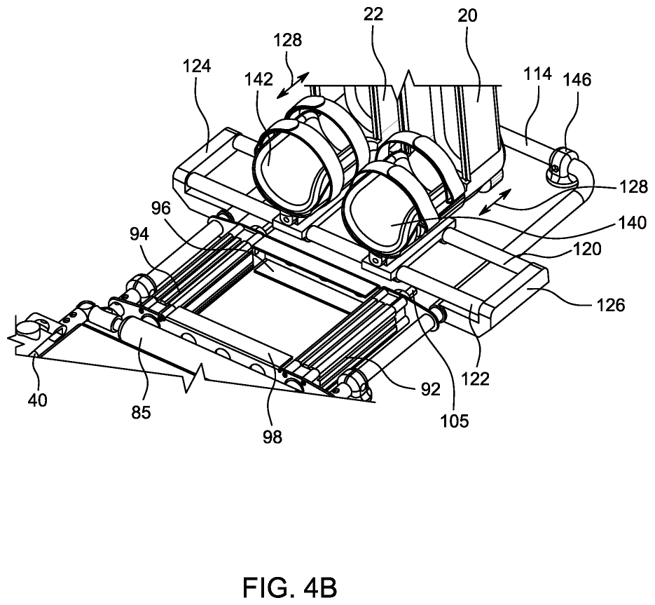

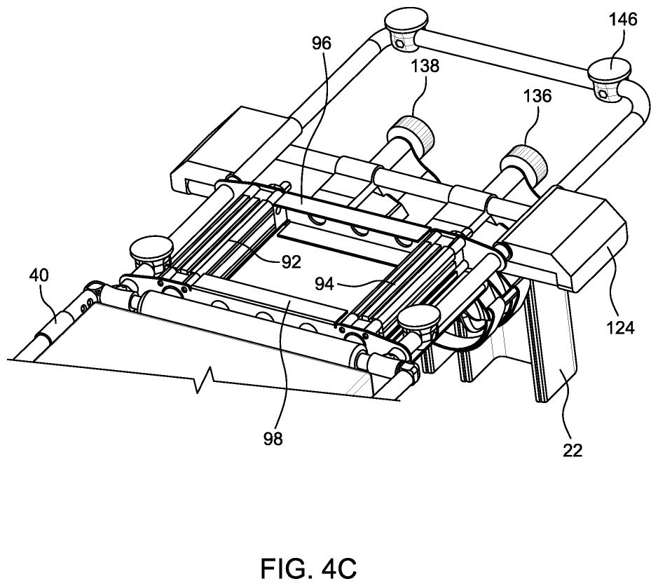

Referring to FIG. 4A, a close-up view of the actuator source generator 90 attached to portions of the intermediate frame portion 40 is shown. The actuator source generator 90 may also include an air pressure gauge and release button 93 (operatively coupled to the release valve 113). FIG. 4B and FIG. 4C illustrate close-up views of the intermediate frame portion 40, illustrating the pneumatic actuators 92 and 94 and piston connection plates 96 and 98.

The intermediate frame portion 40 may be connected to the upper frame portion 38 using one or more frame corner part connectors 100. While an embodiment of the traction device 10 includes a unit that is not foldable, the traction device 10 may be configured to fold. Accordingly, the intermediate frame portion 40 may also be connected to the upper frame portion 38 using one or more hinged connectors 102, thus allowing one or more portions of the traction device 10 to fold up.

The intermediate frame portion first member 80, the intermediate frame portion second member 82, and the cross-bar 84 are preferably arranged to form an intermediate frame portion interior 104. The intermediate frame portion interior 104 is preferably sized to receive a second body support structure 106, illustrated herein as a soft mat configured to support portions of the middle body section of the individual using the traction device 10.

The lower frame portion 42 may include a u-shaped body 108 having a first arm 110, a second arm 112, and a base bar 114 separating the first arm 110 and the second arm 112. The lower frame portion u-shaped body 108 may form a lower frame portion interior 116. The lower frame portion interior 116 is preferably sized to receive a third body support structure 118, illustrated herein as a soft mat configured to support portions of the lower body of the individual using the traction device 10. The lower frame portion 42 may be connected to the intermediate frame portion 40 using one or more frame corner part connectors 100. For the embodiment of the traction device 10 configured to fold, the lower frame portion 42 may also be connected to the intermediate frame portion 40 using one or more hinged connectors 102, thus allowing one or more portions of the traction device 10 to fold up.

The first foot/ankle support 20 and the second foot/ankle support 22 are secured to one or more portions of the lower frame portion 42. In one embodiment, the first foot/ankle support 20 and the second foot/ankle support 22 may be secured to, and movable about, support guide bars 120 and 122. The support guide bars 120 and 122 may be secured to portions of the lower frame portion 42 through ankle support guide bar covers 124 and 126. The ankle support guide bar covers 124 and 126 are configured to allow the support guide bars 120 and 122 to secure thereto at one end, see openings 125 (same for ankle support guide bar cover 124, just not shown) and to secure to portions of the lower frame portion 42 at a second end through securing or fitting within openings 128 and 130 respectively. The ankle support guide bar covers 124 and 126 are movable about lower frame portion first arm 110 and lower frame portion second arm 112 when a force is applied (to the support guide bars 122 when piston 103 moves). This movement causes first foot/ankle support 20 and the second foot/ankle support 22 along lower frame portion first arm 110 and lower frame portion second arm 112.

The first foot/ankle support 20 and the second foot/ankle support 22 may also be secured to and movable about portions of the lower frame portion 42 via the ankle support bases 132 and 134. The ankle support bases 132 and 134 may comprise openings 133 and 135, respectively, to allow being secured to and movable about the support guide bars 120 and 122. Ankle support angle adjustment knobs 136 and 138 allow a user to adjust the angle orientation of the first foot/ankle support 20 and the second foot/ankle support 22. To aid in providing a good fit, the first foot/ankle support 20 and the second foot/ankle support 22 may include ankle support structures 140 and 142. The ankle support structures 140 and 142 may be made of soft material and include straps 144 for use in securing a portion of the user's foot when inserted therein. The ankle support structures 140 and 142 are designed to fit within the vertical walls 143 and 145.

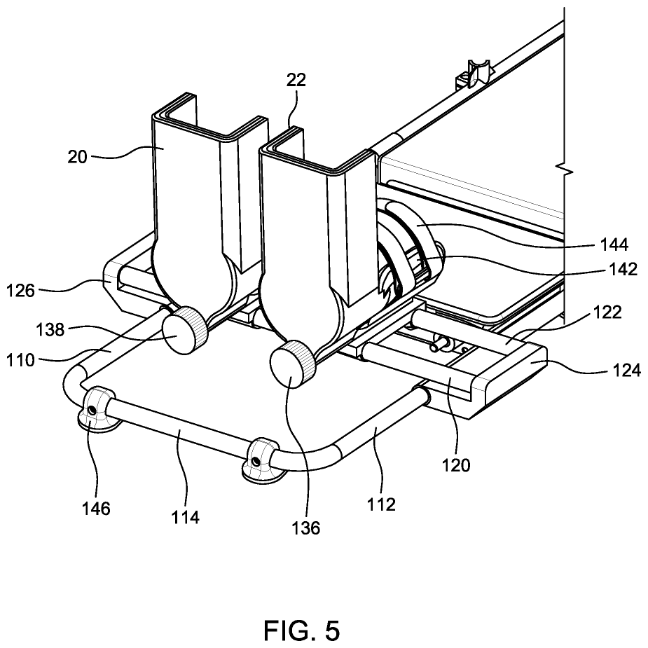

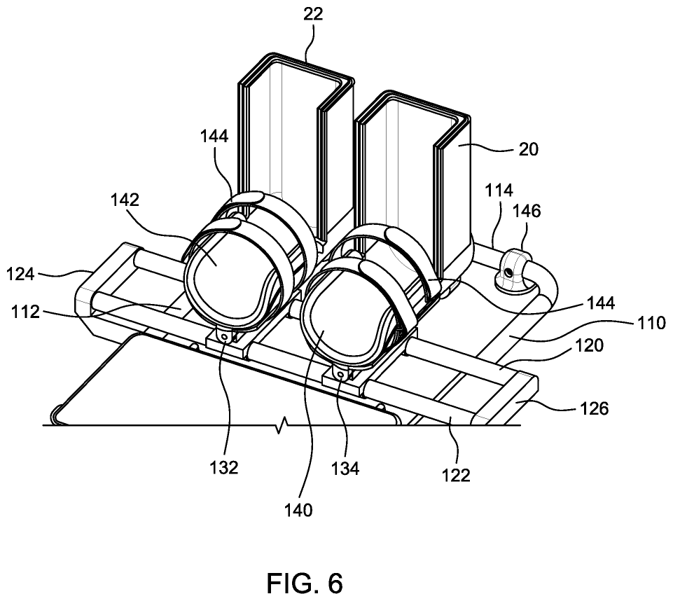

Referring to FIGS. 5 and 6, close-up views of the first foot/ankle support 20 and the second foot/ankle support 22 secured to the lower frame portion 42 are shown to provide additional views of the interconnection.

To prevent the traction device 10 from moving, the lower frame portion 42, or other frame portions, may include one or more feet 146.

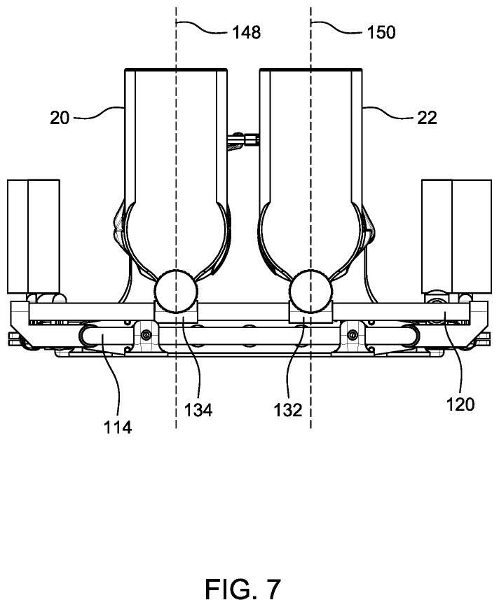

The uniqueness of the traction device 10 allows a user to place and/or orientate his/her feet at different angle orientations, see FIGS. 7-9. Accordingly, the traction device 10 is configured so the first foot/ankle support 20 and the second foot/ankle support 22 may be rotated or angled in various directions. Orientating the user's feet in the various positions allow traction to the user's hips and back, to the user's back alone, or to the user's hips alone. Referring to FIG. 7, the first foot/ankle support 20 and the second foot/ankle support 22 are aligned in a generally parallel orientation. In this case, the first foot/ankle support 20 and the second foot/ankle support 22 are at or near 90 degree relative to the support guide bars 120 and 122, thus orientating the first ankle support longitudinal axis 148 and the second ankle support longitudinal axis 150 in a parallel arrangement. Thus, this arranges the user's feet in corresponding positions or orientations. In this position, the traction device 10 provides traction to the user's hips and back.

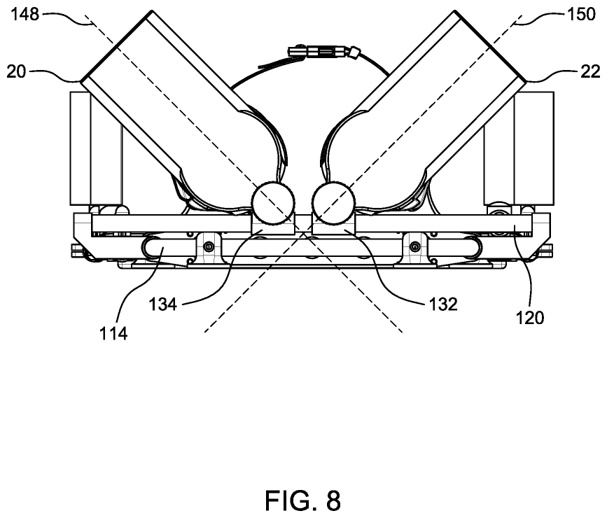

Referring to FIG. 8, the first foot/ankle support 20 and the second foot/ankle support 22 are aligned in an angled, diverging (away from each other) orientation. In this case, the first foot/ankle support 20 and the second foot/ankle support 22 are arranged and fixed at angle greater than 90 degrees relative to the support guide bars 120 and 122, thus orientating the first foot/ankle support longitudinal axis 148 and the second foot/ankle support longitudinal axis 150 in a non-parallel, diverging arrangement. Thus, this arranges the user's feet in corresponding positions or orientations. In this position, the traction device 10 provides traction primarily to the user's back.

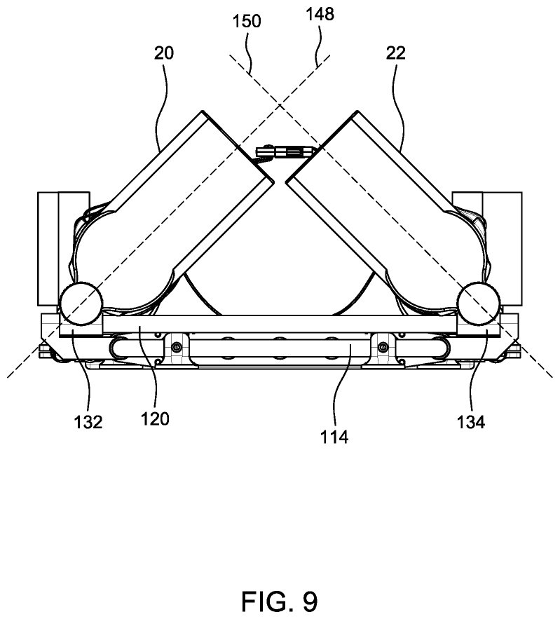

Referring to FIG. 9, the first foot/ankle support 20 and the second foot/ankle support 22 are aligned in an angled, converging (towards each other) orientation. In this case, the first foot/ankle support 20 and the second foot/ankle support 22 are arranged and fixed at angle less than 90 degrees relative to the support guide bars 120 and 122, thus orientating the first foot/ankle support longitudinal axis 148 and the second foot/ankle support longitudinal axis 150 in a non-parallel, converging arrangement. Thus, this arranges the user's feet in corresponding positions or orientations. In this position, the traction device 10 provides traction primarily to the user's hips.

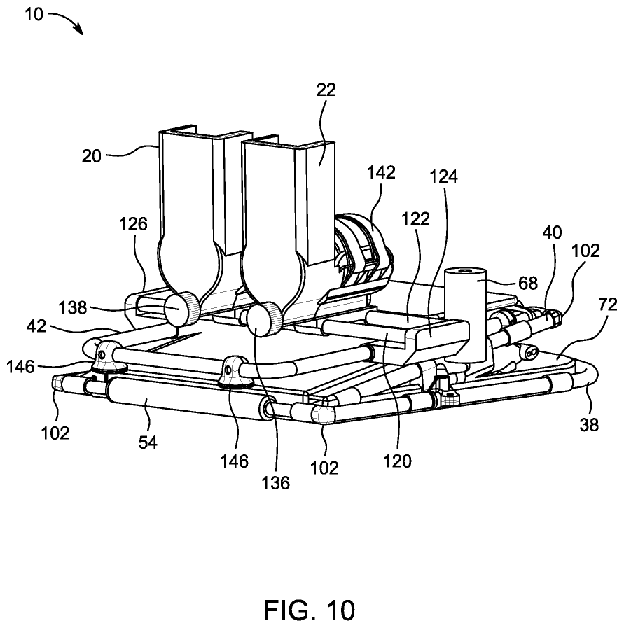

As described previously, the traction device 10 can be configured to fold up. Referring to FIGS. 10-13, the traction device 10 is shown in the folded position. From the orientation shown in FIG. 2, the traction device 10 can be folded for ease of storage or transportation.

In use, a user places his/her body on the traction device 10 in a supine position, i.e. lying horizontally with the face and torso facing up. The user's upper body rests on the upper section 24. The user's mid-section rests on the intermediate section 26 designed to support the user's mid-section. The user's lower body rests on the lower section 28. The user may be secured in place using the chest strap 32, thus preventing the user from sliding down. The first armpit support bar 62 and the second armpit support bar 66 prevent the user's torso from pulling down. To create traction, or pulling down on the user's legs to spread the user's spinal discs apart, the user activates the actuator source generator, i.e. the air pump. This results in activation of the pneumatic actuators 92 and 94 via increased air into the pneumatic actuators 92 and 94, thus increasing the pressure associated with the pneumatic actuators 92 and 94. As the pneumatic actuators 92 and 94 operate, the first foot/ankle support 20 and the second foot/ankle support 22 move (caused by movement of pistons 103 (for example proving a max traction force equal to 100 kgh@6 Bar pressure, 2 piston total), movement of the piston rod 105 and contacting the support guide bar 122) linearly along the lower frame portion first arm 110 and the lower frame portion second arm 112 (see arrows 128, FIG. 4B), resulting in stretching the lower back, the hips, or both the hips and back.

All patents and publications mentioned in this specification are indicative of the levels of those skilled in the art to which the invention pertains.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A device for providing lower back traction for treating or alleviating back pain comprising:
a support structure having a size and shape sufficient to support an individual when resting thereon in a supine position;
a frame connected to and surrounding said support structure;
a first foot holding member sized and shaped to receive and hold a user's first foot when placed thereon, said first foot holding member operatively movably connected to said frame;
a second foot holding member sized and shaped to receive and hold a user's second foot when placed thereon, said second foot holding member operatively movably connected to said frame;
an actuating device operatively connected to said first foot holding member and said second holding member.

2. The device for providing lower back traction for treating or alleviating back pain according to claim 1, wherein said actuating device is a pneumatic cylinder.

3. The device for providing lower back traction for treating or alleviating back pain according to claim 2, wherein said actuating device is connected to a fluid source generator.

4. The device for providing lower back traction for treating or alleviating back pain according to claim 3, wherein said fluid source generator is an air pump.

5. The device for providing lower back traction for treating or alleviating back pain according to claim 4, wherein said air pump is removably attached to said frame.

6. The device for providing lower back traction for treating or alleviating back pain according to claim 1, wherein said support structure is a mat.

7. The device for providing lower back traction for treating or alleviating back pain according to claim 1, wherein said frame is foldable.

8. The device for providing lower back traction for treating or alleviating back pain according to claim 1, wherein said frame includes at least one hinged connector.

9. The device for providing lower back traction for treating or alleviating back pain according to claim 1, further including a restraining device.

10. The device for providing lower back traction for treating or alleviating back pain according to claim 9, wherein said restraining device is an adjustable strap.

11. The device for providing lower back traction for treating or alleviating back pain according to claim 1, wherein said frame comprises an upper section designed to support the user's upper body, an intermediate section designed to support the user's mid-section, and a lower section designed to support the user's lower body.

12. The device for providing lower back traction for treating or alleviating back pain according to claim 1, further including one or more handles or grips.

13. The device for providing lower back traction for treating or alleviating back pain according to claim 1, wherein at least one of said one or more handles or grips is adjustably secured to said frame.

14. The device for providing lower back traction for treating or alleviating back pain according to claim 1, further including an air pressure gauge, a release button, or combinations thereof.

15. The device for providing lower back traction for treating or alleviating back pain according to claim 1, further including an actuator release button.

16. The device for providing lower back traction for treating or alleviating back pain according to claim 1, wherein said first ankle support and said second ankle support are adjustably secured to a bracket.

17. The device for providing lower back traction for treating or alleviating back pain according to claim 1, wherein said first ankle support is oriented in a parallel arrangement with said second ankle support.

18. The device for providing lower back traction for treating or alleviating back pain according to claim 1, wherein said first ankle support is oriented in an angled arrangement with said second ankle support.

19. The device for providing lower back traction for treating or alleviating back pain according to claim 1, wherein said first ankle support and said second ankle support are adjustable between a first position in which said first ankle support is oriented in a parallel arrangement with said second ankle support, a second position in which said first ankle support and said second ankle support are each rotated up to about 45 degrees inwardly, or a third position in which said first ankle support and said second ankle support are each rotated up to about 45 degrees outwardly.
